(19) United States
(12) Patent Application Publication
(10) Pub. No.: US 2018/0196805 A1
(43) Pub. Date: Jul. 12, 2018

(54) SYSTEM AND METHOD FOR IMAGE OPTIMIZATION

(71) Applicant: ScientiaMobile, Inc., Reston, VA (US)

(72) Inventors: STEVE KAMERMAN, Ashburn, VA (US); Jon Arne Saeteraas, Sandnes (NO); Luca Passani, Ashburn, VA (US)

(21) Appl. No.: 15/864,672

(22) Filed: Jan. 8, 2018

Related U.S. Application Data
(60) Provisional application No. 62/443,200, filed on Jan. 6, 2017.

(51) Int. Cl. G06F 17/30

(52) U.S. Cl. CPC G06F 17/3028; G06F 9/5005; G06F 17/30876; G06F 17/30247

(57) ABSTRACT

A method, computer program product, and computer system for receiving, by a first cluster of computing devices, a first request sent by a client for an image. It may be determined that an optimized version of the image is unavailable at the first cluster of computing devices. The first request may be placed in a queue for processing at the first cluster of computing devices. A response to the first request may be sent to the client that temporarily directs the client to send a second request for the image to a second cluster of computing devices. The second request for the image sent by the client may be received at the second cluster of computing devices. The image may be optimized to generate the optimized version of the image. The optimized version of the image may be sent to the client.

### RELATED CASES

This application claims the benefit of U.S. Provisional Application No. 62/443,200, filed on 6 Jan. 2017, the contents of which are all incorporated by reference.

### BACKGROUND

Generally, a computing device (e.g., server) may include a data repository (e.g., a device description repository (DDR)). Generally, DDRs may be used, for example, to maintain device information that may be used to detect the capabilities (e.g., properties, attributes, etc.) of client electronic devices and their associated run-time applications. For instance, some computing devices and their run-time applications (e.g., browser) may vary with regard to, e.g., characteristics (e.g., screen size, support for a certain CSS property, support for a certain video codec, etc.), extension formats (e.g., WBMP, GIF, MP3, WMV), browser behavior (e.g., Openwave WML, XHTML-MP support), and formatting/speed/image layout (e.g., MMS formatting, sender/receiver clients). In the example, the DDR may map HTTP Request headers to a profile of an HTTP client (e.g., a desktop computer, a mobile device, a tablet computer, etc.) that issued a given data request, and may identify the image formats of the requested data (e.g., JPEG). Once the format is identified, the image may be optimized (e.g., transformed, compressed, format converted, etc.) for viewing depending on characteristics (e.g., screen size, resolution, etc.) of the requesting client device.

Typically, a large amount of client requests may be for images that have already been optimized for previous clients. After the first request for a specific image by a specific type of client, the optimized version of the image may be generated in the optimization process and cached (e.g., at an edge server) for faster retrieval in the future. The process of, e.g., resizing images, may be difficult in real-time because, e.g., it may be computationally expensive and time-consuming.

### BRIEF SUMMARY OF DISCLOSURE

In one example implementation, a method, performed by one or more computing devices, may include but is not limited to receiving, by a first cluster of computing devices, a first request sent by a client for an image. It may be determined that an optimized version of the image is unavailable at the first cluster of computing devices. The first request may be placed in a queue for processing at the first cluster of computing devices. A response to the first request may be sent to the client that temporarily directs the client to send a second request for the image to a second cluster of computing devices. The second request for the image sent by the client may be received at the second cluster of computing devices. The image may be optimized to generate the optimized version of the image. The optimized version of the image may be sent to the client.

One or more of the following example features may be included. The response to the first request made by the client that temporarily directs the client to send the second request for the image to the second cluster of computing devices may include an HTTP 307 response. A token may be provided to a first image fetching thread to make a connection to an origin server where the image is originally stored. The token may provide the first thread exclusive access to the origin server for the image until the first thread finishes. Metadata of the image obtained from an origin cache may be combined with a response header of image data of the image to create a combined response header. The metadata of the image may be combined with the response header of the image data as a base64-encoded JSON object. It may be determined whether the image is available in the origin cache using a single query request to the origin cache using the combined response header.

In another example implementation, a computing system may include one or more processors and one or more memories configured to perform operations that may include but are not limited to receiving, by a first cluster of computing devices, a first request sent by a client for an image. It may be determined that an optimized version of the image is unavailable at the first cluster of computing devices. The first request may be placed in a queue for processing at the first cluster of computing devices. A response to the first request may be sent to the client that temporarily directs the client to send a second request for the image to a second cluster of computing devices. The second request for the image sent by the client may be received at the second cluster of computing devices. The image may be optimized to generate the optimized version of the image. The optimized version of the image may be sent to the client.

One or more of the following example features may be included. The response to the first request made by the client that temporarily directs the client to send the second request for the image to the second cluster of computing devices may include an HTTP 307 response. A token may be provided to a first image fetching thread to make a connection to an origin server where the image is originally stored. The token may provide the first thread exclusive access to the origin server for the image until the first thread finishes. Metadata of the image obtained from an origin cache may be combined with a response header of image data of the image to create a combined response header. The metadata of the image may be combined with the response header of the image data as a base64-encoded JSON object. It may be determined whether the image is available in the origin cache using a single query request to the origin cache using the combined response header.

In another example implementation, a computer program product may reside on a computer readable storage medium having a plurality of instructions stored thereon which, when executed across one or more processors, may cause at least a portion of the one or more processors to perform operations that may include but are not limited to receiving, by a first cluster of computing devices, a first request sent by a client for an image. It may be determined that an optimized version of the image is unavailable at the first cluster of computing devices. The first request may be placed in a queue for processing at the first cluster of computing devices. A response to the first request may be sent to the client that temporarily directs the client to send a second request for the image to a second cluster of computing devices. The second request for the image sent by the client may be received at the second cluster of computing devices. The image may be optimized to generate the optimized version of the image. The optimized version of the image may be sent to the client.

One or more of the following example features may be included. The response to the first request made by the client that temporarily directs the client to send the second request for the image to the second cluster of computing devices may include an HTTP 307 response. A token may be provided to a first image fetching thread to make a connection to an origin server where the image is originally stored. The token may provide the first thread exclusive access to the origin server for the image until the first thread finishes. Metadata of the image obtained from an origin cache may be combined with a response header of image data of the image to create a combined response header. The metadata of the image may be combined with the response header of the image data as a base64-encoded JSON object. It may be determined whether the image is available in the origin cache using a single query request to the origin cache using the combined response header.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of an image optimization process coupled to an example distributed computing network according to one or more example implementations of the disclosure;

FIG. 2 is an example diagrammatic view of a computer of FIG. 1 according to one or more example implementations of the disclosure;

FIG. 3 is an example flowchart of an image optimization process according to one or more example implementations of the disclosure; and

FIG. 4 is an example alternative diagrammatic view of an image optimization process coupled to a computing network according to one or more example implementations of the disclosure.

Like reference symbols in the various drawings indicate like elements.

### DETAILED DESCRIPTION

System Overview:

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

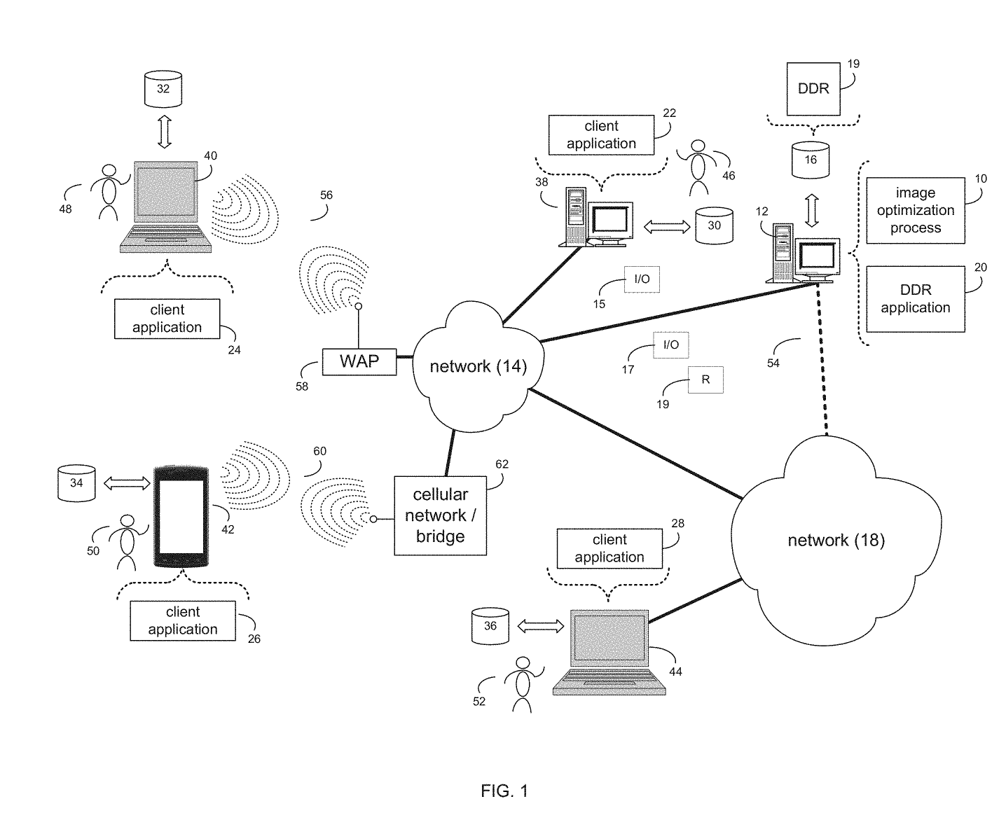

Referring now to the example implementation of FIG. 1, there is shown image optimization process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). As is known in the art, a SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, an image optimization process, such as image optimization process 10 of FIG. 1, may receive, by a first cluster of computing devices, a first request (e.g., I/O request 15) sent by a client for an image. It may be determined that an optimized version of the image is unavailable at the first cluster of computing devices. The first request may be placed in a queue for processing at the first cluster of computing devices. A response (e.g., response 19) to the first request may be sent to the client that temporarily directs the client to send a second request (e.g., I/O request 17) for the image to a second cluster of computing devices. The second request for the image sent by the client may be received at the second cluster of computing devices. The image may be optimized to generate the optimized version of the image. The optimized version of the image may be sent to the client.

In some implementations, the instruction sets and subroutines of image optimization process 10, which may be stored on storage device, such as storage device 16, coupled to computer 12, may be executed by one or more processors and one or more memory architectures included within computer 12. In some implementations, storage device 16 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 16 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 14 may be connected to one or more secondary networks (e.g., network 18), examples of which may include but are not limited to: a local area network; a wide area network; or an intranet, for example.

In some implementations, computer 12 may include a data repository (e.g., device description repository (DDR) 19), such as a database (e.g., relational database, object-oriented database, etc.) and may be located within any suitable memory location, such as storage device 16 coupled to computer 12. Generally, DDRs may be used, for example, to maintain device information that may be used to detect the capabilities (e.g., properties, attributes, etc.) of client electronic devices (e.g., client electronic devices 38, 40, 42, 44) and the associated run-time application (e.g., run-times) of the client electronic devices. For instance, some computing devices and their run-time applications (e.g., browser) may vary with regard to, e.g., characteristics (e.g., screen size, support for a certain CSS property, support for a certain video codec, etc.), extension formats (e.g., WBMP, GIF, MP3, WMV), browser behavior (e.g., Openwave WML, XHTML-MP support), and formatting/speed/image layout (e.g., MMS formatting, sender/receiver clients). Generally, the DDR may map HTTP Request headers to a profile of an HTTP client ((e.g., a desktop computer, a mobile device, a tablet computer, etc.) that issued a given request (e.g., I/O request 15 and/or I/O request 17) that may be sent between, e.g., client applications 22, 24, 26, 28 and computer 12), and may identify the image formats of the requested data (e.g., JPEG) such that it may be optimized (e.g., via IO process 10) for viewing depending on characteristics (e.g., screen size, resolution, etc.) of the requesting client device. An example of DDR 19 may include but is not limited to Wireless Universal Resource FiLe (WURFL) DDR; however, those skilled in the art will appreciate that other DDRs may also be used without departing from the scope of this disclosure.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML, database. In some implementations, any other form(s) of a data storage structure and/or organization may also be used. In some implementations, image optimization process 10 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute a DDR application (e.g., DDR application 20), examples of which may include, but are not limited to, e.g., the above-noted WURFL application, or other application that allows for the identification of client computing devices (and their respective characteristics) and/or the optimization of data to be viewed on the client computing device. In some implementations, image optimization process 10 and/or DDR application 20 may be accessed via one or more of client applications 22, 24, 26, 28. In some implementations, image optimization process 10 may be a standalone application, or may be an applet/application/script/extension that may interact with and/or be executed within DDR application 20, a component of DDR application 20, and/or one or more of client applications 22, 24, 26, 28. In some implementations, DDR application 20 may be a standalone application, or may be an applet/application/script/extension that may interact with and/or be executed within image optimization process 10, a component of image optimization process 10, and/or one or more of client applications 22, 24, 26, 28. In some implementations, one or more of client applications 22, 24, 26, 28 may be a standalone application, or may be an applet/application/script/extension that may interact with and/or be executed within and/or be a component of image optimization process 10 and/or DDR application 20. Examples of client applications 22, 24, 26, 28 may include, but are not limited to, e.g., the above-noted WURFL application, or other application that allows for the identification of client computing devices (and their respective characteristics) and/or the optimization of data to be viewed on the client computing device, a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet, a server, a television, a smart television, a media (e.g., video, photo, etc.) capturing device, and a dedicated network device. Client electronic devices 38, 40, 42, 44 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 22, 24, 26, 28 may be configured to effectuate some or all of the functionality of image optimization process 10 (and vice versa). Accordingly, in some implementations, image optimization process 10 may be a purely server-side application, a purely client-side application, or a hybrid server-side/client-side application that is cooperatively executed by one or more of client applications 22, 24, 26, 28 and/or image optimization process 10.

In some implementations, one or more of client applications 22, 24, 26, 28 may be configured to effectuate some or all of the functionality of DDR application 20 (and vice versa). Accordingly, in some implementations, DDR application 20 may be a purely server-side application, a purely client-side application, or a hybrid server-side/client-side application that is cooperatively executed by one or more of client applications 22, 24, 26, 28 and/or DDR application 20. As one or more of client applications 22, 24, 26, 28, image optimization process 10, and DDR application 20, taken singly or in any combination, may effectuate some or all of the same functionality, any description of effectuating such functionality via one or more of client applications 22, 24, 26, 28, image optimization process 10, DDR application 20, or combination thereof, and any described interaction(s) between one or more of client applications 22, 24, 26, 28, image optimization process 10, DDR application 20, or combination thereof to effectuate such functionality, should be taken as an example only and not to limit the scope of the disclosure.

In some implementations, one or more of users 46, 48, 50, 52 may access computer 12 and image optimization process 10 (e.g., using one or more of client electronic devices 38, 40, 42, 44) directly through network 14 or through secondary network 18. Further, computer 12 may be connected to network 14 through secondary network 18, as illustrated with phantom link line 54. Image optimization process 10 may include one or more user interfaces, such as browsers and textual or graphical user interfaces, through which users 46, 48, 50, 52 may access image optimization process 10.

In some implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, 802.11n, 802.11ac, Wi-Fi®, RFID, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown by example directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

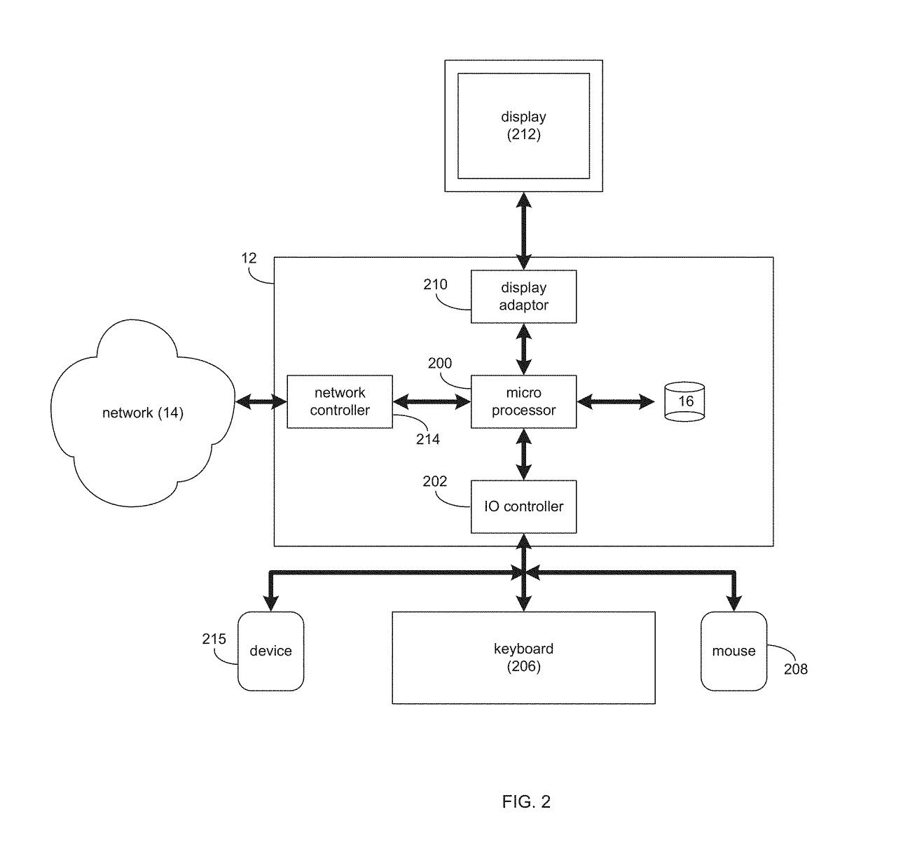

Referring also to the example implementation of FIG. 2, there is shown a diagrammatic view of computer 12. While computer 12 is shown in this figure, this is for example purposes only and is not intended to be a limitation of this disclosure, as other configurations are possible. Additionally, any computing device capable of executing, in whole or in part, image optimization process 10 may be substituted for computer 12 (in whole or in part) within FIG. 2, examples of which may include but are not limited to one or more of client electronic devices 38, 40, 42, 44.

In some implementations, computer 12 may include a processor (e.g., microprocessor 200) configured to, e.g., process data and execute the above-noted code/instruction sets and subroutines. Microprocessor 200 may be coupled via a storage adaptor to the above-noted storage device(s) (e.g., storage device 16). An I/O controller (e.g., I/O controller 202) may be configured to couple microprocessor 200 with various devices (e.g., via wired or wireless connection), such as keyboard 206, pointing/selecting device (e.g., touchpad, touchscreen, mouse 208, etc.), custom device (e.g., device 215), USB ports, and printer ports. A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to the above-noted network 14 (e.g., the Internet or a local area network).

As discussed above, a computing device (e.g., server) may include a DDR to maintain device information that may be used to detect the capabilities (e.g., properties, attributes, etc.) of client electronic devices and their associated run-time applications. For instance, some computing devices and their run-time applications (e.g., browser) may vary with regard to, e.g., characteristics (e.g., screen size, support for a certain CSS property, support for a certain video codec, etc.), extension formats (e.g., WBMP, GIF, MP3, WMV), browser behavior (e.g., Openwave WML, XHTML-MP support), and formatting/speed/image layout (e.g., MMS formatting, sender/receiver clients). In the example, the DDR may map HTTP Request headers to a profile of an HTTP client ((e.g., a desktop computer, a mobile device, a tablet computer, etc.) that issued a given data request, and may format the requested data (e.g., an image) such that it may be optimized (e.g., transformed, compressed, format converted, etc.) for viewing depending on characteristics (e.g., screen size, resolution, etc.) of the requesting client device.

Typically, a large amount of client requests may be for images that have already been optimized for previous clients. After the first request for a specific image by a specific type of client, the optimized version of the image may be generated in the optimization process and cached (e.g., at an edge server) for faster retrieval in the future. The process of, e.g., resizing images, may be difficult in real-time because, e.g., it may be computationally expensive and time-consuming. Thus, as will be discussed below, image optimization process 10 may at least help, e.g., improve existing technology necessarily rooted in computer technology in order to overcome an example and non-limiting problem specifically arising in the realm of computer networks associated with, e.g., image optimization and servicing data requests over the computer networks in a more efficient manner.

The Image Optimization Process:

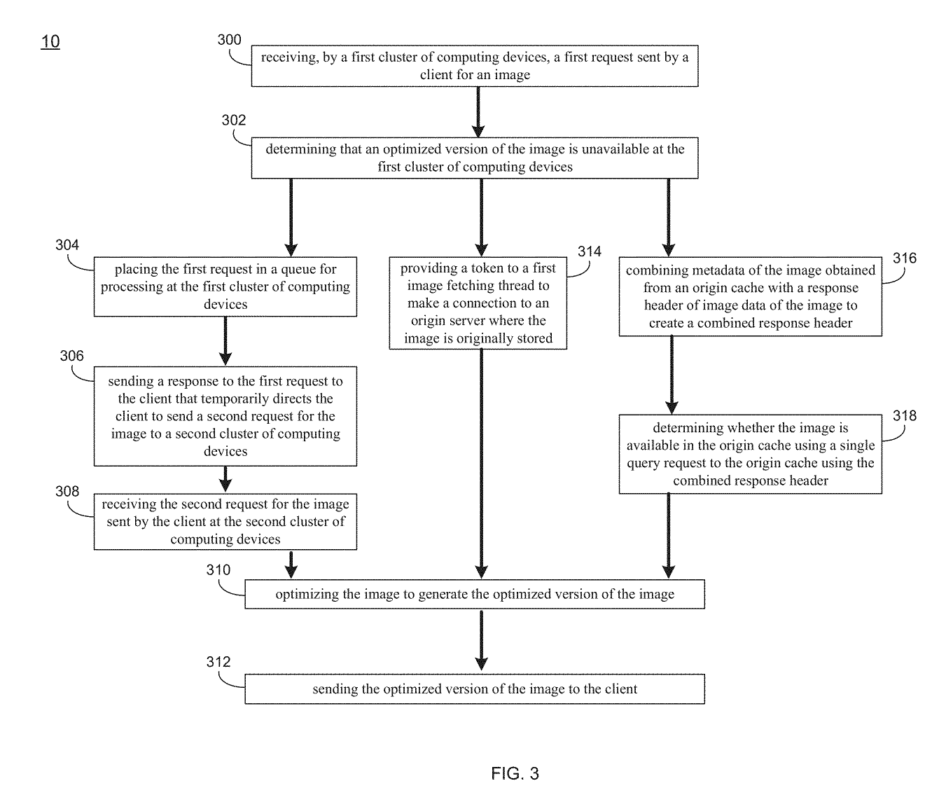

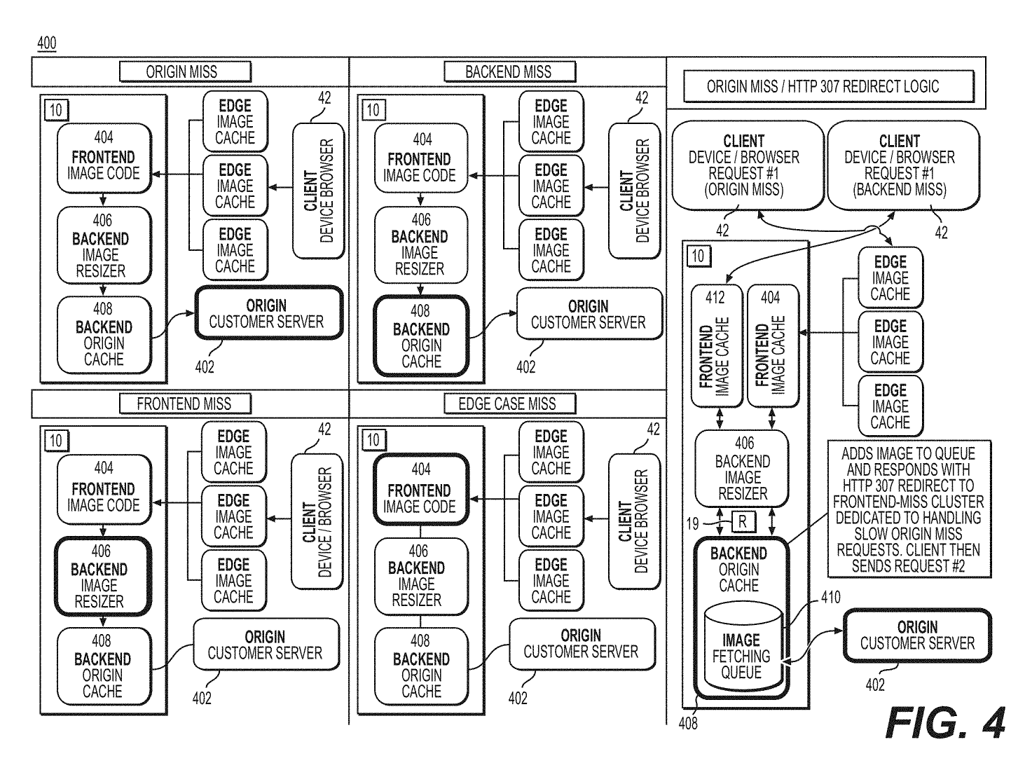

As discussed above and referring also at least to the example implementations of FIGS. 3-4, image optimization (TO) process 10 may receive 300, by a first cluster of computing devices, a first request sent by a client for an image. TO process 10 may determine 302 that an optimized version of the image is unavailable at the first cluster of computing devices. TO process 10 may place 304 the first request in a queue for processing at the first cluster of computing devices. TO process 10 may send 306 a response to the first request to the client that temporarily directs the client to send a second request for the image to a second cluster of computing devices. TO process 10 may receive 308 the second request for the image sent by the client at the second cluster of computing devices. TO process 10 may optimize 310 the image to generate the optimized version of the image. TO process 10 may send 312 the optimized version of the image to the client.

As noted above, a large amount of client requests may be for images that have already been optimized for previous clients. After the first request for a specific image by a specific type of client, the optimized version of the image may be generated in the optimization process and cached (e.g., at an edge server) for faster retrieval in the future. The process of, e.g., resizing images, may be difficult in real-time because, e.g., it may be computationally expensive and time-consuming. In some implementations, IO process 10 may help address this example and non-limiting problem by, e.g., redirecting clients that request resources needing to be optimized (e.g., resized) in real-time to another set of servers (“MISS” servers), and in some implementations, when the request arrives at the “MISS” servers, it may be placed into a deduplicated queue, and in some implementations, once the image processing is complete, the image data and associated metadata may be returned in an optimized, single response.

For instance, in some implementations, IO process 10 may receive 300, by a first cluster of computing devices, a first request sent by a client for an image. Assume for example purposes only that a user (e.g., user 50) uses a client electronic device (e.g., client electronic device 42) to request visual data (e.g., an image). In the example, client electronic device 42 may send a first request (e.g., I/O request 15) for the image.

In the example, and referring at least to the example implementation of FIG. 4, the requested image may have been originally stored in an origin server (e.g., origin/customer server 402) within environment 400. Generally, environment 400 may include one or more example distinct layers. For instance, the above-noted first cluster may include a frontend (e.g., frontend 404). In the example, frontend 404 may be located at the edge of the network (e.g., network 14/18), and may be the receiving layer to which client electronic device 42 sends I/O request 15. In some implementations, frontend 404 (e.g., via 10 process 10) may perform “aggressive” caching of content (e.g., image data) and may determine the image optimizations that are to be made for those requests (e.g., based upon the above-noted DDR) that have not already been cached, e.g., due to previous image requests by a similar client electronic device. For instance, as noted above, the optimization of the image may depend upon the particular characteristics (e.g., screen size) of the requesting device, which may be determined using known DDR techniques. These uncached requests may continue on to the backend (e.g., backend 406). Generally, when a system is caching aggressively, it is going out of its way to cache anything that could possibly be cached. The opposite would generally be a “conservative” caching approach, where things are only cached if there is no doubt about the cacheability. Consider that some content does not provide a caching policy, so the caching duration, or whether the content may be cached at all, is unknown. An aggressive strategy generally will cache this, a conservative one generally will not.

In some implementations, backend 406 may be the layer that performs (e.g., via TO process 10) the actual optimizations of the image, based on the commands sent by frontend 404. In some implementations, at this layer, the original image may be cached, and in some implementations, only the original image is cached. If the original image is not in the local cache of backend 406, backend 406 (e.g., via TO process 10) may request the original image from an origin cache (e.g., origin cache 408).

In some implementations, origin cache 408 may be the layer that maintains (e.g., via TO process 10) a cache of the original client images, along with some metadata that describes the images (e.g., image dimensions, EXIF data, server response headers, ttl). If the requested image is not available in origin cache 408, origin cache 408 (e.g., via TO process 10) may fetch it from the original location of the non-optimized original version of the image on the client's (or third-party's) server (e.g., origin server 402).

In some implementations, TO process 10 may determine 302 that an optimized version of the image is unavailable at the first cluster of computing devices. For instance, assume for example purposes only that there are four different levels of caching efficacy that may be achieved for cache-miss segmentation. For example:

HIT: Frontend 404 may serve the optimized version of the requested image from its local cache (e.g., due to the image previously having been requested, optimized, and stored from a similar client electronic device as client electronic device 42).

MISS: Frontend 404 did not have a copy of the requested image in its local cache, and a request was sent to backend 406. In the example, backend 406 had a copy of the requested image in its local cache and delivered an optimized version back to frontend 404 for subsequent delivery to client electronic device 42.

BACKEND MISS: Frontend 404 did not have a copy of the requested image in its local cache, and a request was sent to backend 406. In the example, backend 406 did not have a copy of the requested image in its local cache, and a request was sent to origin cache 408. Further in the example, origin cache 408 had a copy of the requested image in its local cache and delivered it to backend 406, which delivered an optimized version back to frontend 404 for subsequent delivery to client electronic device 42.

ORIGIN MISS: Frontend 404 did not have a copy of the requested image in its local cache, and a request was sent to backend 406. In the example, backend 406 did not have a copy of the requested image in its local cache, and a request was sent to origin cache 408. Further in the example, origin cache 408 did not have a copy of the requested image in its local cache, so origin cache 408 (e.g., via IO process 10) fetched it from the client's origin server 402 and delivered it to backend 406, which delivered an optimized version back to frontend 404 for subsequent delivery to client electronic device 42.

In some implementations, IO process 10 may place 304 the first request in a queue for processing at the first cluster of computing devices, in some implementations, IO process 10 may send 306 a response (e.g., an HTTP 307 response) to the first request to the client that temporarily directs the client to send a second request for the image to a second cluster of computing devices, and in some implementations, IO process 10 may receive 308 the second request for the image sent by the client at the second cluster of computing devices. For example, the performance difference between the different cache efficacy categories may be dramatic, and may vary by, e.g., three orders of magnitude or more. In order to achieve greater performance, if IO process 10 determines 302 that the request would end in an ORIGIN MISS (e.g., whereby there is no available copy of the image in any of the three layers of the first cluster of one or more computing devices), origin cache 408 may (e.g., via 10 process 10) put I/O request 15 in a queue (e.g., image fetching queue 410) for processing and may return an HTTP 307 response (e.g., response 19) to the request made by client electronic device 42. The first request may be answered with the HTTP 307 Temporary Redirection response code, which tells client electronic device 42 that the requested content has been moved temporarily to a new location. The “Location” header may be included in that HTTP 307 response, which may provide client electronic device 42 the URL of the new location. The first request is then generally considered complete, and client electronic device 42 now knows that it must make a second request to get the content that it has requested. Thus, in the example, the HTTP 307 may temporarily redirect 110 request 15 as a second request (e.g., I/O request 17) from client electronic device 42 to a different cluster of servers (“MISS CLUSTER” such as frontend-miss cluster layer 412), which may be specifically tuned to handle these long-lived requests (where the primary cluster of servers may generally be referred to as the “HIT CLUSTER.”) In some implementations, all subsequent requests for the same image may be redirected to the second cluster (MISS CLUSTER) until the first thread has successfully fetched the image from origin server 402. As such, although the first client (client electronic device 42) is the one that results in the image fetching job to be added to the queue, it and all other requests for that image, may be redirected to the second cluster of servers to sit and wait for the image. Once the image is present in origin cache 408, no more clients will be redirected. In the example, since the latency of client electronic device 42 may be expected to be relatively high with an ORIGIN MISS, there may be a chance, e.g., of greater than 50% in some implementations, that by the time client electronic device 42 returns with 110 request 17, origin cache 408 may have already downloaded the image from origin server 402, optimized 310 the image to generate the optimized version of the image at backend 406, and client electronic device 42 may be served with the optimized image sent 312 by frontend-miss 412 “immediately” (e.g., in real-time). That is, when client electronic device 42 sent the first request, origin cache 408 (e.g., via IO process 10) may have identified that the requested image was not present in its local cache, and thus added a job to the image fetching queue and sent the above-noted HTTP 307 response back to client electronic device 42. In parallel, for example, IO process 10 may be monitoring the image fetching queue and noticed the new image fetching job, to then start to fetch the image. By the time client electronic device 42 sent the second request, this image fetching job may already be complete, in which case client electronic device 42 would not need to wait for the image to be fetched. If the image is not yet ready (e.g., not having yet downloaded the image from origin server 402), client electronic device 42 (as well as any other client electronic devices that may be waiting for it) may be delayed until the image is available, or a timeout is reached.

Thus, this example technique of segmenting out those requests that may likely cause a significant delay may have the following example and non-limiting benefits: (1) Dramatic reduction in the number of open client connections in all three layers of the HIT CLUSTER, (2) Mitigation of Denial of Service attacks in which the service is flooded with requests for unique image URLs, (3) Mitigation of downtime from a service overload, in which a massive, legitimate burst of traffic is experienced, and (4) Scaling may be optimized by allowing the MISS CLUSTER to be scaled independently of the HIT CLUSTER, which may also apply to the independent geographic distribution of MISS CLUSTERS.

In some implementations, IO process 10 may be beneficial for use in a Parallel Deduplicated Image Fetching Queue. For example, in some implementations, IO process 10 may provide 314 a token to a first image fetching thread to make a connection to origin server 402 where the image is originally stored, and in some implementations, the token may provide the first thread exclusive access to origin server 402 for the image until the first thread finishes. For instance, assume for example purposes only that origin cache 408 layer may be responsible (e.g., via IO process 10) for fetching the original images from the client's servers (e.g., origin server 402), computing and storing metadata with them (e.g., image dimensions, EXIF data, server response headers, ttl), and delivering them via, e.g., a RESTful API to backend 406 layer.

In the example, in a high-traffic environment, it may be likely that multiple client electronic devices may request an image before the first client electronic device has received a response. In a typical queueing implementation, these client electronic devices may all stand in line, and each of the requests may be handled in parallel batches. This approach may, for example, be inefficient, as it may take some time to fetch the original image from the client's server (e.g., origin server 402), which may cause many requests to be sent to origin server 402 in parallel for the same image.

In some implementations, to help mitigate this inefficiency, IO process 10 may provide 314 a token to the first image fetching thread to make a connection to the origin server for a given image, which may provide the first image fetching thread (and thus the first client to make the connection to the origin server for the given image requested) exclusive access to origin server 402 for that image. All other threads waiting on that image may then wait on that first thread to finish. That is, once the first thread causes an image fetching job to be enqueued, all the threads that are requesting that image will generally wait for that job to finish. Once finished, all the threads may receive that image that was downloaded (cached) as a result of the first thread triggering the image fetching job. As a result, IO process 10 may serve to deduplicate image fetching requests and significantly improve performance of origin cache 408 layer by making less connections to origin server 402, and by sending less requests overall.

In some implementations, IO process 10 may be beneficial for use in Single-Request Image and Metadata Delivery. For example, in some implementations, IO process 10 may combine 316 metadata of the image obtained from origin cache 408 with a response header of image data of the image to create a combined response header. In some implementations, the metadata of the image may be combined with the response header of the image data as, e.g., a base64-encoded JSON object, and in some implementations, IO process 10 may determine 318 whether the image is available in origin cache 408 using a single query request to origin cache 408 using the combined response header. For instance, assume for example purposes only that the origin cache 408 layer may be responsible (e.g., via IO process 10) for fetching images from the client's servers (e.g., origin server 402), computing and storing metadata with them (e.g., image dimensions, EXIF data, server response headers, ttl), and delivering them via, e.g., a RESTful API to backend 406 layer.

Generally, when origin cache 408 (e.g., via IO process 10) fetches an image from origin server 402, origin cache 408 (e.g., via IO process 10) may analyze it to determine, e.g., the image MIME type, EXIF data, dimensions etc. In the example, this information, along with the client origin server's HTTP Response Headers, may be stored by IO process 10 along with the image as metadata. For example, when an image is requested from the origin server, the image itself may be received with an HTTP response, which may include a status, such as “HTTP/1.1 200 OK”, and other, optional headers such as “Content-Type: image/jpeg” or “Content-Length: 3048882” or “Server: nginx”. These headers may be arbitrarily set by the remote server, and IO process 10 may store them for analysis, and may pass some of these headers through to the end-users. Some images may contain additional metadata, such as the model of the camera that took the picture image, or the geo-location where the picture was taken. In some implementations, IO process 10 may store this data in a database, however, it will be appreciated that other methods and standards may be used to enable IO process 10 to preserve as much of the origin server response as possible or desired. In order to reduce the number of requests required to collect both the image data and the metadata from origin cache 408, IO process 10 may combine 316 the metadata with the image data's HTTP response headers as, e.g., a base64-encoded JSON object (or other appropriate object).

As a result of this technique of combining two different pieces of information (i.e., the metadata and image data) in a single HTTP response, backend 406 may be enabled to query origin cache 408, and within a single request (as opposed to multiple requests typically required with traditional techniques), IO process 10 may determine 318 if the image is available. If the image is available, IO process 10 may return it and the metadata as noted above. In some implementations, serving this response with a single response may, e.g., reduce the number of request destined for origin cache 408 by, e.g., at least 50% over traditional techniques.

While one or more of the above examples may be described using HTTP, it will be appreciated that the present disclosure may be implemented using any appropriate communication protocol. As such, the use of HTTP should be used as example only and not to otherwise limit the scope of the disclosure. Similarly, using HTTP 307 should also be taken as example only, as other example HTTP codes may be used, for example, but not limited to, 301, 302 and 308.

It will also be appreciated that the example environment 400 may vary as appropriate to provide the example and non-limiting benefits of the present disclosure. As such, the specific layout of environment 400 should be used as example only and not to otherwise limit the scope of the disclosure.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
receiving, by a first cluster of computing devices, a first request sent by a client for an image;
determining that an optimized version of the image is unavailable at the first cluster of computing devices;
placing the first request in a queue for processing at the first cluster of computing devices;
sending a response to the first request to the client that temporarily directs the client to send a second request for the image to a second cluster of computing devices;
receiving the second request for the image sent by the client at the second cluster of computing devices;
optimizing the image to generate the optimized version of the image; and
sending the optimized version of the image to the client.

2. The computer-implemented method of claim 1 wherein the response to the first request made by the client that temporarily directs the client to send the second request for the image to the second cluster of computing devices includes an HTTP 307 response.

3. The computer-implemented method of claim 1 further comprising providing a token to a first image fetching thread to make a connection to an origin server where the image is originally stored.

4. The computer-implemented method of claim 3 wherein the token provides the first thread exclusive access to the origin server for the image until the first thread finishes.

5. The computer-implemented method of claim 1 further comprising combining metadata of the image obtained from an origin cache with a response header of image data of the image to create a combined response header.

6. The computer-implemented method of claim 5 wherein the metadata of the image is combined with the response header of the image data as a base64-encoded JSON object.

7. The computer-implemented method of claim 5 further comprising determining whether the image is available in the origin cache using a single query request to the origin cache using the combined response header.

8. A computer program product residing on a computer readable storage medium having a plurality of instructions stored thereon which, when executed across one or more processors, causes at least a portion of the one or more processors to perform operations comprising:
receiving, by a first cluster of computing devices, a first request sent by a client for an image;
determining that an optimized version of the image is unavailable at the first cluster of computing devices;
placing the first request in a queue for processing at the first cluster of computing devices;
sending a response to the first request to the client that temporarily directs the client to send a second request for the image to a second cluster of computing devices;
receiving the second request for the image sent by the client at the second cluster of computing devices;
optimizing the image to generate the optimized version of the image; and sending the optimized version of the image to the client.

9. The computer program product of claim 8 wherein the response to the first request made by the client that temporarily directs the client to send the second request for the image to the second cluster of computing devices includes an HTTP 307 response.

10. The computer program product of claim 8 wherein the operations further comprise providing a token to a first image fetching thread to make a connection to an origin server where the image is originally stored.

11. The computer program product of claim 10 wherein the token provides the first thread exclusive access to the origin server for the image until the first thread finishes.

12. The computer program product of claim 8 wherein the operations further comprise combining metadata of the image obtained from an origin cache with a response header of image data of the image to create a combined response header.

13. The computer program product of claim 12 wherein the metadata of the image is combined with the response header of the image data as a base64-encoded JSON object.

14. The computer program product of claim 12 wherein the operations further comprise determining whether the image is available in the origin cache using a single query request to the origin cache using the combined response header.

15. A computing system including one or more processors and one or more memories configured to perform operations comprising:
receiving, by a first cluster of computing devices, a first request sent by a client for an image;
determining that an optimized version of the image is unavailable at the first cluster of computing devices;
placing the first request in a queue for processing at the first cluster of computing devices;
sending a response to the first request to the client that temporarily directs the client to send a second request for the image to a second cluster of computing devices;
receiving the second request for the image sent by the client at the second cluster of computing devices;
optimizing the image to generate the optimized version of the image; and sending the optimized version of the image to the client.

16. The computing system of claim 15 wherein the response to the first request made by the client that temporarily directs the client to send the second request for the image to the second cluster of computing devices includes an HTTP 307 response.

17. The computing system of claim 15 wherein the operations further comprise providing a token to a first image fetching thread to make a connection to an origin server where the image is originally stored.

18. The computing system of claim 17 wherein the token provides the first thread exclusive access to the origin server for the image until the first thread finishes.

19. The computing system of claim 15 wherein the operations further comprise combining metadata of the image obtained from an origin cache with a response header of image data of the image to create a combined response header.

20. The computing system of claim 19 wherein the metadata of the image is combined with the response header of the image data as a base64-encoded JSON object.

21. The computing system of claim 19 wherein the operations further comprise determining whether the image is available in the origin cache using a single query request to the origin cache using the combined response header.
